(19) United States
(12) Patent Application Publication
(10) Pub. No.: US 2025/0349834 A1
(43) Pub. Date: Nov. 13, 2025

(54) POSITIVE ELECTRODE ACTIVE MATERIAL, MANUFACTURING METHOD THEREOF, AND SECONDARY BATTERY

(71) Applicant: SEMICONDUCTOR ENERGY LABORATORY CO., LTD., Atsugi-shi, Kanagawa-ken (JP)

(72) Inventors: Noriko MIYAIRI, Hadano, Kanagawa (JP); Yusuke YOSHITANI, Isehara, Kanagawa (JP); Takashi HIRAHARA, Isehara, Kanagawa (JP); Tetsuji ISHITANI, Atsugi, Kanagawa (JP)

(21) Appl. No.: 18/871,300

(22) PCT Filed: Jun. 12, 2023
(86) PCT No.: PCT/IB2023/056016

§ 371 Date: Dec. 3, 2024

(30) Foreign Application Priority Data
Jun. 24, 2022 (JP) 2022-101687

(51) Int. Cl. H01M 4/36; H01M 4/02; H01M 4/525; H01M 4/62

(52) U.S. Cl. CPC H01M 4/366; H01M 4/525; H01M 4/628; H01M 2004/021

(57) ABSTRACT

One embodiment of the present invention provides a novel positive electrode active material, or a highly safe secondary battery. The positive electrode active material is manufactured in such a manner that after a nickel compound (also referred to as a precursor) containing nickel, cobalt, and manganese is obtained by a coprecipitation method, a mixture obtained by mixing a lithium compound and the nickel compound is heated at a first heating temperature, the heated mixture is crushed or ground and then heated at a second heating temperature which is higher than the first temperature, and magnesium is mixed and a third heat treatment is performed.

### TECHNICAL FIELD

One embodiment of the present invention relates to an object, a method, or a manufacturing method. Alternatively, the present invention relates to a process, a machine, manufacture, or a composition (composition of matter). One embodiment of the present invention relates to a power storage device including a secondary battery, a semiconductor device, a display device, a light-emitting device, a lighting device, an electronic device, or a manufacturing method thereof.

Electronic devices in this specification generally mean devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, air batteries, and all-solid-state batteries have been actively developed. In particular, demand for lithium-ion secondary batteries with high output and a high capacity has rapidly grown with the development of the semiconductor industry. The lithium-ion secondary batteries are essential as rechargeable energy supply sources for today's information society.

In particular, secondary batteries for mobile electronic devices, for example, are highly demanded to have high discharge capacity per weight and excellent cycle performance. In order to meet such demands, positive electrode active materials in positive electrodes of secondary batteries have been actively improved (e.g., Patent Document 1).

### Reference

### Patent Document

[Patent Document 1] Japanese Published Patent Application No. 2020-068210

### SUMMARY OF THE INVENTION

### Problems to be Solved by the Invention

An object of one embodiment of the present invention is to provide a positive electrode active material that is less likely to deteriorate. Another object is to provide a novel positive electrode active material. Another object is to provide a highly safe or highly reliable secondary battery. Another object is to provide a secondary battery that hardly deteriorates. Another object is to provide a long-life secondary battery. Another object is to provide a novel secondary battery.

Note that the description of these objects does not preclude the existence of other objects. One embodiment of the present invention does not need to achieve all these objects. Other objects can be derived from the descriptions of the specification, the drawings, and the claims. Means for Solving the Problems

For a lithium-ion secondary battery, what is called NCM represented by LiNi_{X}Co_{Y}Mn_{Z}O₂ (X+Y+Z=1) is generally used. A material containing transition metals at approximately the same ratios, like Ni:Co:Mn=1:1:1, contains a large amount of cobalt, which is a noble metal, and thus is likely to result in a high cost. There is an attempt to increase the capacity of batteries by reducing the use amount of cobalt and increasing the use amount of nickel.

NCM with a large use amount of nickel has a problem in that oxygen is easily released and deterioration is likely to occur. Furthermore, there is also a problem in that a phenomenon called cation mixing in which a transition metal typified by nickel and manganese enters a site for lithium ions to be inserted or extracted in charging and discharging is likely to occur.

In NCM, a plurality of primary particles are aggregated to form a secondary particle. Through charging or discharging, lithium ions are inserted or extracted, whereby the primary particles expand or contract. The primary particles' expansion or contraction causes a volume change, and release of the primary particles' aggregation induces the secondary particle to crack or become miniaturized. One of the causes of cracking or miniaturization is a change in the a-axis or the c-axis of an NCM crystal due to repeated charging or discharging, which increases a void between primary particles. Note that the expression “a void between primary particles” does not mean that the void space is empty, but there is an electrolyte solution in the void when a secondary battery is formed. Note that the void is empty when an all-solid-state battery is formed.

In a secondary battery, a positive electrode where a positive electrode active material layer in which powdery NCM is mixed with a conductive additive and is bound with a binder is formed over a current collector is used. The secondary particle included in the positive electrode active material layer contains primary particles, and when the crack or miniaturization generated between the primary particles increases, following the volume change at the time of charging and discharging of the secondary battery, the lifetime characteristics of the secondary battery deteriorate and the resistance increases. When the crack or miniaturization is generated in the secondary particle of NCM, a portion of the positive electrode where electron conduction is not ensured increases, so that the internal resistance increases, which reduces the lifetime characteristics of the secondary battery.

Thus, to solve at least one of the plurality of problems described above, magnesium is added to NCM, whereby a crack generated between primary particles is reduced at the time of charging and discharging, and the lifetime characteristics of the secondary battery are improved.

It is desirable that magnesium be appropriately weighed by a practitioner in the range of greater than or equal to 0.5 atomic % and less than or equal to 3 atomic %, in consideration of the composition of the nickel compound before addition, and added such that a desired amount is contained.

A secondary particle is an aggregate of a plurality of primary particles, and there is a gap between the primary particles in the secondary particle. The primary particle includes a polycrystal or a single crystal. When a secondary battery is manufactured, not only the outer surface of a secondary particle formed by aggregation of a plurality of primary particles but also an inner void or a portion where a connection between the primary particles is incomplete comes in contact with an electrolyte solution. Thus, insertion and extraction of lithium is possible in a region in contact with the electrolyte solution, which leads to an advantage of the capacity characteristics being improved. On the other hand, if the region in contact with the electrolyte solution is unstable, there might be a disadvantage in that degradation of that portion is accelerated and the cycle performance decreases.

In a structure disclosed in this specification, a positive electrode active material is manufactured in such a manner that after a nickel compound (also referred to as a precursor) containing nickel, cobalt, and manganese is obtained by a coprecipitation method, a mixture obtained by mixing the nickel compound and a lithium compound is heated at a first temperature and, after the heated mixture is crushed or ground, a magnesium compound is mixed, and heating at a second temperature that is a temperature higher than the first temperature is further performed.

More specifically, it is a method for manufacturing a positive electrode active material, including: supplying an aqueous solution containing a water-soluble nickel salt, a water-soluble cobalt salt, and a water-soluble manganese salt, and an alkaline solution to a reaction vessel and mixing the aqueous solution and the alkaline solution in the reaction vessel to precipitate a compound containing at least nickel, cobalt, and manganese; heating a first mixture of the compound and a lithium compound at a first heating temperature and crushing or grinding the first mixture; heating the first mixture at a second heating temperature; and heating a second mixture obtained by mixing the crushed or ground first mixture and a magnesium compound at a third heating temperature.

Moisture is released by the heating at the first temperature, and then heating is performed at the second temperature that is higher than the first temperature. Performing the heat treatment twice can improve the mixing state of the mixture, and when a secondary battery is manufactured with the mixture, voids of secondary particles can be reduced. Furthermore, performing the heat treatment twice can improve the crystallinity.

The first heating temperature is higher than or equal to 400° C. and lower than or equal to 750° C.

The range of the second heating temperature and the third heating temperature is higher than 750° C. and lower than or equal to 1050° C.

By the coprecipitation method for precipitating the nickel compound, the aqueous solution containing the water-soluble nickel salt, the water-soluble cobalt salt, and the water-soluble manganese salt the alkaline solution are supplied to the reaction vessel, and mixing is performed in the reaction vessel to precipitate the nickel compound (hydroxide containing cobalt, manganese, and nickel). The reaction is referred to as a neutralization reaction, an acid-base reaction, or a coprecipitation reaction in some cases. The compound containing at least nickel, cobalt, and manganese is referred to as a cobalt compound or a precursor of lithium cobalt oxide in some cases regardless of the contained amount of cobalt. Then, a mixture of the nickel compound and the lithium compound is obtained.

As the aqueous solution containing the water-soluble nickel salt, a nickel sulfate aqueous solution or a nickel nitrate aqueous solution can be used.

As the aqueous solution containing the water-soluble cobalt salt, a cobalt sulfate aqueous solution or a cobalt nitrate aqueous solution can be used.

As the aqueous solution containing the water-soluble manganese salt, a manganese sulfate aqueous solution or a manganese nitrate aqueous solution can be used.

The pH of the mixed solution in the reaction vessel is preferably greater than or equal to 9.0 and less than or equal to 12.0, further preferably greater than or equal to 10.0 and less than or equal to 11.5.

When the aqueous solution and the alkaline solution are mixed to precipitate the cobalt compound, a chelate agent is added. Examples of the chelate agent include glycine, oxine, 1-nitroso-2-naphthol, 2-mercaptobenzothiazole, and EDTA (ethylenediaminetetraacetic acid). Note that two or more kinds selected from glycine, oxine, 1-nitroso-2-naphthol, and 2-mercaptobenzothiazole may be used. The chelate agent is dissolved in pure water, which is used as a chelate aqueous solution. The chelate agent serves as a complexing agent to form a chelate compound, and is preferred to a general complexing agent. Needless to say, a complexing agent other than the chelate agent may be used, and ammonia water can be used as the complexing agent.

The use of the chelate aqueous solution is preferable because it makes it easy to control the pH of the mixed solution existing in the reaction vessel for obtaining a cobalt compound. Furthermore, the use of the chelate aqueous solution is preferable also because the chelate aqueous solution suppresses generation of unnecessary crystal nuclei and promotes crystal growth. Since generation of unnecessary crystal nuclei is suppressed to inhibit generation of fine particles, a composite oxide with good particle size distribution can be obtained. Furthermore, the use of the chelate aqueous solution can slow an acid-base reaction, so that the reaction gradually progresses to form a nearly spherical secondary particle. Glycine has a function of keeping the pH greater than or equal to 9.0 and less than or equal to 10.0 or the vicinity of the range. Using a glycine aqueous solution as the chelate aqueous solution is preferable because it makes it easy to control the pH of the reaction vessel when obtaining the cobalt compound. Furthermore, the concentration of glycine in the glycine aqueous solution is preferably greater than or equal to 0.05 mol/L and less than or equal to 0.09 mol/L in the aqueous solution.

The positive electrode active material obtained by the above method includes a secondary particle, and the secondary particle includes a plurality of primary particles.

The positive electrode active material obtained by the above-described method includes crystal having a hexagonal crystal layered structure. The crystal is not limited to a single crystal (also referred to as a crystallite). In the case where the crystal is polycrystalline, some crystallites gather to form a primary particle. The primary particle indicates a particle recognized as a single grain when observed with an SEM. The secondary particle indicates a group of aggregated primary particles. For the aggregation of the primary particles, there is no particular limitation on the bonding force between the plurality of primary particles. The bonding force may be any of covalent bonding, ionic bonding, a hydrophobic interaction, the Van der Waals force, and other molecular interactions, or a plurality of bonding forces may work together. When the coprecipitation method is employed, the secondary particle is formed in some cases.

The crystal having a hexagonal crystal layered structure includes one or more selected from a first transition metal, a second transition metal, and a third transition metal. Specifically, NiCoMn-based material (also referred to as NCM) represented by LiNiₓCo_{y}Mn_{z}O₂ (x>0, y>0, z>0, 0.8<x+y+z<1.2) where the first transition metal is nickel, the second transition metal is cobalt, and the third transition metal is manganese, can be used. Specifically, 0.1x<y<8x and 0.1x<z<8x are preferably satisfied, for example. For example, x, y, and z preferably satisfy x:y:z=1:1:1 or the neighborhood thereof. Alternatively, for example, x, y, and z preferably satisfy x:y:z=5:2:3 or the neighborhood thereof. Alternatively, for example, x, y, and z preferably satisfy x:y:z=8:1:1 or the neighborhood thereof. Alternatively, for example, x, y, and z preferably satisfy x:y:z=9:0.5:0.5 or the neighborhood thereof. Alternatively, for example, x, y, and z preferably satisfy x:y:z=6:2:2 or the neighborhood thereof. Alternatively, for example, x, y, and z preferably satisfy x:y:z=1:4:1 or the neighborhood thereof.

The positive electrode active material includes a secondary particle, the secondary particle includes a plurality of primary particles, and at least one primary particle of the plurality of primary particles includes, in its surface portion, a layer containing magnesium. The thickness of the layer containing magnesium is greater than or equal to 1 nm and less than or equal to 10 nm. Magnesium is added to NCM, whereby cracks generated between primary particles are reduced at the time of charging and discharging, and the lifetime characteristics of the secondary battery are improved.

The secondary battery including the positive electrode active material is also a structure disclosed in this specification. The secondary battery includes a positive electrode including the positive electrode active material and a negative electrode including a negative electrode active material. In addition, a separator is included between the positive electrode and the negative electrode. The separator is used for preventing short circuit; thus, a secondary battery with high safety or high reliability can be provided.

### Effect of the Invention

Performing heat treatment twice in one embodiment of the present invention improves the mixing state of the mixture, which can reduce voids of secondary particles when a secondary battery is manufactured. In addition, performing heat treatment three times, two times before the addition of magnesium and one time after the addition, can improve the crystallinity. Thus, a positive electrode active material which is relatively stable even when charge and discharge are repeated can be provided. A highly safe or highly reliable secondary battery can be provided.

Note that the description of these effects does not preclude the existence of other effects. Note that one embodiment of the present invention does not necessarily need to have all these effects. Other effects will be apparent from the description of the specification, the drawings, and the claims, and other effects can be derived from the description of the specification, the drawings, and the claims.

### BRIEF DESCRIPTION OF THE DRAWINGS

FIG. 1A is a schematic view illustrating the appearance of a secondary particle, and FIG. 1B is a schematic view illustrating an example of a cross section of the secondary particle.

FIG. 2A is a diagram illustrating an example of a cross section of a secondary particle, and FIG. 2B is a schematic diagram illustrating an example of a cross section of the secondary particle.

FIG. 3 is an example of a flow chart of a manufacturing process showing one embodiment of the present invention.

FIG. 4 is an example of a flow chart of a manufacturing process showing one embodiment of the present invention.

FIG. 5A is an exploded perspective view of a coin-type secondary battery, FIG. 5B is a perspective view of the coin-type secondary battery, and FIG. 5C is a cross-sectional perspective view thereof.

FIG. 6A illustrates an example of a cylindrical secondary battery. FIG. 6B illustrates an example of the cylindrical secondary battery. FIG. 6C illustrates an example of a plurality of cylindrical secondary batteries. FIG. 6D illustrates an example of a power storage system including the plurality of cylindrical secondary batteries.

FIG. 7A and FIG. 7B are diagrams illustrating examples of a secondary battery, and FIG. 7C is a diagram illustrating the internal state of the secondary battery.

FIG. 8A to FIG. 8C are diagrams illustrating an example of the secondary battery.

FIG. 9A and FIG. 9B are external views of a secondary battery.

FIG. 10A to FIG. 10C are diagrams illustrating a method for manufacturing a secondary battery.

FIG. 11A is a perspective view of a battery pack of one embodiment of the present invention, FIG. 11B is a block diagram of the battery pack, and FIG. 11C is a block diagram of a vehicle including the battery pack.

FIG. 12A to FIG. 12D are diagrams illustrating examples of transport vehicles. FIG. 12E is a diagram illustrating an example of an artificial satellite.

FIG. 13A is a diagram illustrating an electric bicycle, FIG. 13B is a diagram illustrating a secondary battery of the electric bicycle, and FIG. 13C is a diagram illustrating a motor scooter.

FIG. 14A to FIG. 14D are diagrams illustrating examples of electronic devices.

FIG. 15 is a planar SEM image of a positive electrode active material of this example.

FIG. 16A shows cycle test results with the vertical axis representing discharge capacity, and FIG. 16B shows cycle test results with the vertical axis representing capacity retention rate.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

In this specification and the like, particles are not necessarily spherical (with a circular cross section). Other examples of the cross-sectional shapes of particles include an ellipse, a rectangle, a trapezoid, a pyramid, a quadrilateral with rounded corners, and an asymmetrical shape, and a particle may have an indefinite shape.

Uniformity refers to a state where, in a solid made of a plurality of elements (e.g., A, B, and C), a certain element (e.g., A) is distributed with similar features in specific regions. Note that it is acceptable for the specific regions to have substantially the same concentration of the element. For example, a difference in the detected amount of the certain element (e.g., the count number obtained by STEM-EDX) between the specific regions is 10% or less. Examples of the specific regions include a surface portion, a surface, a projected portion, a depressed portion, and an inner portion.

A positive electrode active material to which an additive element is added is sometimes referred to as a composite oxide, a positive electrode member, a positive electrode material, a secondary battery positive electrode member, or the like. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite.

In the case where the features of individual particles of a positive electrode active material are described in the following embodiment and the like, not all the particles necessarily have the features. When 50% or more, preferably 70% or more, further preferably 90% or more of three or more randomly selected particles of a positive electrode active material have the features, for example, it can be said that an effect of improving the characteristics of the positive electrode active material and a secondary battery including the positive electrode active material is sufficiently obtained.

A short circuit of a secondary battery might cause not only a malfunction in charging operation and/or discharging operation of the secondary battery but also heat generation and ignition. In order to obtain a safe secondary battery, a short-circuit current is preferably inhibited even at a high charge voltage. In the positive electrode active material of one embodiment of the present invention, a short-circuit current is inhibited even at a high charge voltage. Thus, a secondary battery having a high discharge capacity and a high level of safety can be obtained.

The description is made on the assumption that materials (such as a positive electrode active material, a negative electrode active material, an electrolyte, and a separator) of a secondary battery have not deteriorated unless otherwise specified. A decrease in discharge capacity due to aging treatment (also referred to as burn-in treatment) during the manufacturing process of a secondary battery is not regarded as deterioration. For example, the case where discharge capacity is higher than or equal to 97% of the rated capacity of a lithium-ion secondary battery cell and an assembled lithium secondary battery (hereinafter, referred to as a lithium-ion secondary battery) can be regarded as a non-deteriorated state. The rated capacity conforms to JIS C 8711:2019 in the case of a lithium-ion secondary battery for a portable device. The rated capacities of other lithium-ion secondary batteries conform to JIS described above, JIS for electric vehicle propulsion, industrial use, and the like, standards defined by IEC, and the like.

In some cases, materials included in a secondary battery that have not deteriorated are referred to as initial products or materials in an initial state, and materials that have deteriorated (have discharge capacity lower than 97% of the rated capacity of the secondary battery) are referred to as products in use, materials in a used state, products that are already used, or materials in an already-used state.

### Embodiment 1

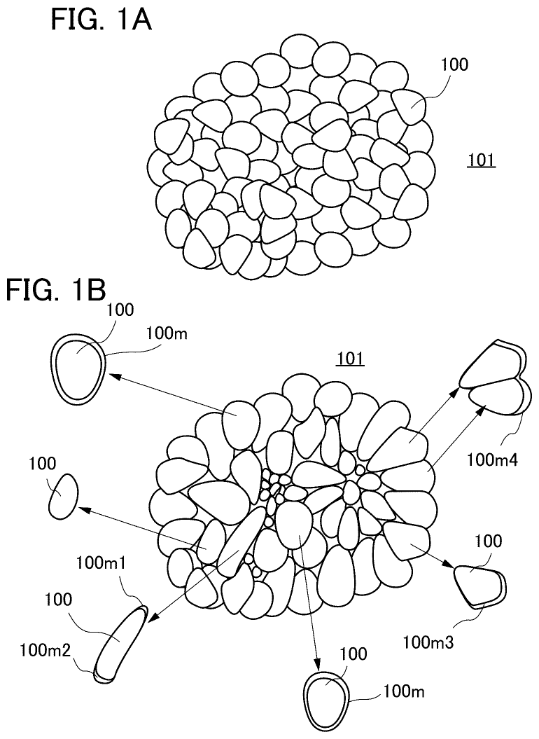

In this embodiment, a positive electrode active material 101 of one embodiment of the present invention is described with reference to FIG. 1.

The positive electrode active material 101 contains lithium, a transition metal M, and oxygen. The transition metal M is one or two or more selected from nickel, manganese, and cobalt. In addition to these, magnesium is preferably contained as an additive element. Alternatively, the positive electrode active material 101 can contain lithium nickel-manganese-cobalt oxide to which an additive element is added.

A positive electrode active material of a lithium-ion secondary battery needs to contain a transition metal which can take part in an oxidation-reduction reaction in order to maintain a neutrally charged state even when lithium ions are inserted and extracted. The positive electrode active material 101 of one embodiment of the present invention contains nickel, manganese, and cobalt as the transition metals M which take part in an oxidation-reduction reaction.

FIG. 1A is a schematic view illustrating an example of the appearance of the positive electrode active material 101. As illustrated in FIG. 1A, a plurality of primary particles 100 aggregate to form one secondary particle. Note that a layer 100m containing magnesium is not illustrated in FIG. 1A.

FIG. 1B illustrates an example of a schematic cross-sectional view of the positive electrode active material 101.

In FIG. 1B, a variety of examples in which the primary particles constituting the secondary particle are provided with a layer containing magnesium are shown. FIG. 1B shows a plurality of portions which are some primary particles that are indicated by arrows and their surface portions.

There are some cases where the layer 100m containing magnesium is provided on the entire surface portion of the primary particle 100, and other cases where the primary particle 100 not provided with the layer containing magnesium is mixed. There are also cases where a layer 100m1 and a layer 100m2 each containing magnesium are provided at both ends of the primary particle 100. There are also cases where even a primary particle placed in the center portion of the secondary particle is provided with the layer 100m containing magnesium on the entire surface portion of the primary particle 100. There are also cases where a layer 100m3 containing magnesium is provided on only one side. There are also cases where a layer 100m4 containing magnesium is provided, being shared by two primary particles.

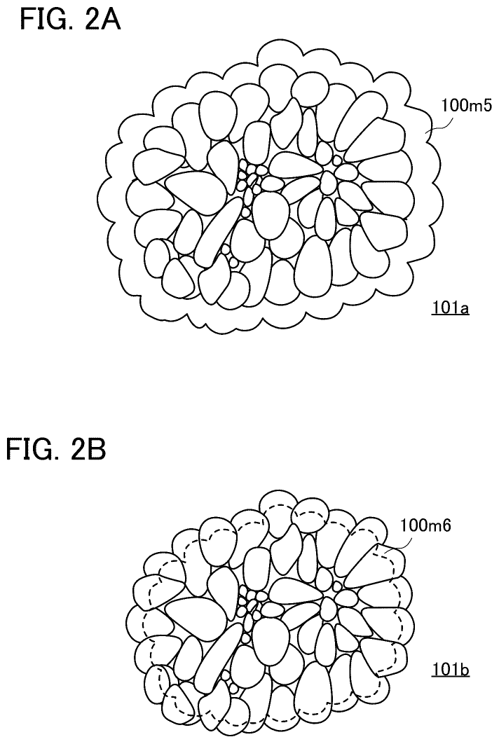

FIG. 2A illustrates an example of a schematic cross-sectional view of a positive electrode active material 101a. FIG. 2A illustrates an example in which a layer 100m5 containing magnesium is provided to cover the entire outer surface of the positive electrode active material 101a.

FIG. 2B also illustrates an example of a schematic cross-sectional view of a positive electrode active material 101b. FIG. 2B illustrates an example in which a layer 100m6 containing magnesium is provided in a surface portion of the positive electrode active material 101b. As to FIG. 2B, it can be said that the surface portion of the positive electrode active material 101b and the layer 100m6 containing magnesium correspond to each other.

Any of the structures, i.e., the positive electrode active material 101 in FIG. 1B, the positive electrode active material 101a in FIG. 2A, and the positive electrode active material 101b in FIG. 2B, or a structure similar to these can be obtained, depending on a manufacturing method of a positive electrode active material, specifically, various conditions such as heating temperature, the amount of magnesium source to be mixed, the material of the magnesium source, and the timing at which magnesium is added.

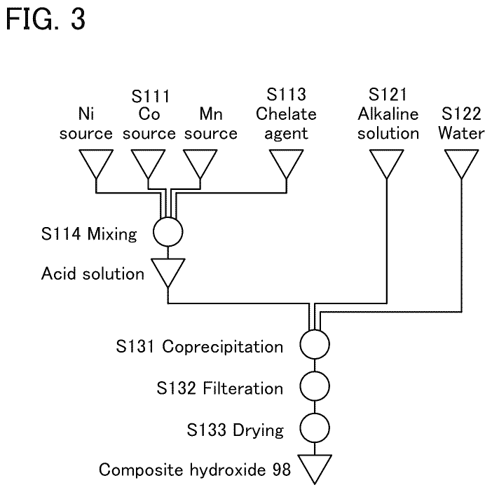

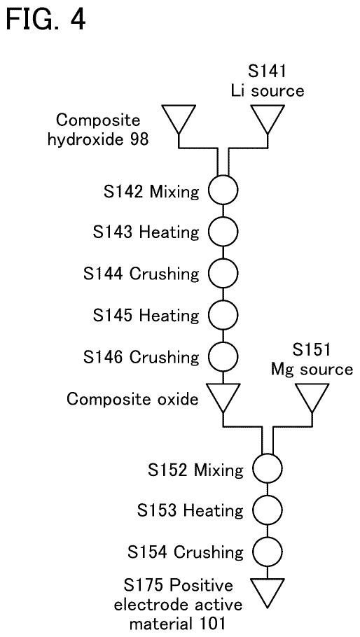

An example of a method for manufacturing the positive electrode active material 101 is described below with reference to FIG. 3 and FIG. 4.

### Step S111

In Step S111 in FIG. 3, first, a transition metal M source, i.e., a nickel source (Ni source), a cobalt source (Co source), and a manganese source (Mn source) are prepared. The mixed ratio of nickel, cobalt, and manganese is preferably within a range with which a layered rock-salt crystal structure can be obtained.

It is particularly preferable that the transition metal M contained in the positive electrode active material 101 contain a large amount of nickel, in which case the cost of the raw material may be lower than that in the case of containing a large amount of cobalt and charge and discharge capacity per weight may be increased. For example, the proportion of nickel in the transition metal M is preferably higher than 25 atomic %, further preferably higher than or equal to 60 atomic %, and still further preferably higher than or equal to 80 atomic %. However, when the proportion of nickel is too high, the chemical stability and heat resistance might decrease. Thus, the proportion of nickel in the transition metal M is preferably lower than or equal to 95 atomic %.

The transition metal M preferably contains cobalt, in which case the average discharging voltage is high and a secondary battery can be highly reliable because cobalt contributes to stabilization of the layered rock-salt crystal structure.

The transition metal M preferably contains manganese, in which case the heat resistance and chemical stability are improved. However, a too high proportion of manganese tends to decrease a discharging voltage and a discharge capacity. For this reason, the proportion of manganese in the transition metal M is preferably higher than or equal to 2.5 atomic % and lower than or equal to 34 atomic %.

As the transition metal M source, an aqueous solution containing the transition metal M is prepared. As the nickel source, an aqueous solution of nickel salt can be used. As the nickel salt, nickel sulfate, nickel chloride, nickel nitrate, or a hydrate thereof can be used, for example. Furthermore, an organic acid salt of nickel typified by nickel acetate or a hydrate thereof can also be used. As the nickel source, an aqueous solution of nickel alkoxide or an organic nickel complex can also be used. In this specification and the like, the term “organic acid salt” denotes a compound of a metal and an organic acid such as an acetic acid, a citric acid, an oxalic acid, a formic acid, or a butyric acid.

Similarly, an aqueous solution of cobalt salt can be used as the cobalt source. As the cobalt salt, cobalt sulfate, cobalt chloride, cobalt nitrate, or a hydrate thereof can be used, for example. Furthermore, an organic acid salt of cobalt typified by cobalt acetate or a hydrate thereof can also be used. As the cobalt source, an aqueous solution of cobalt alkoxide or an organic cobalt complex can be used.

Similarly, an aqueous solution of manganese salt can be used as the manganese source. As the manganese salt, manganese sulfate, manganese chloride, manganese nitrate, or an aqueous solution thereof can be used. Furthermore, an organic acid salt of manganese typified by manganese acetate or a hydrate thereof can also be used. As the manganese source, an aqueous solution of manganese alkoxide or an organic manganese complex can be used.

In this embodiment, an aqueous solution in which nickel sulfate, cobalt sulfate, and manganese sulfate are dissolved in pure water is prepared as the transition metal M source. In this case, the atomic ratio of nickel, cobalt, and manganese is expressed by Ni:Co:Mn=8:1:1 or in the neighborhood thereof. The aqueous solution is acidic.

### Step S113

As shown in Step S113 in FIG. 3, a chelate agent may be prepared. Examples of the chelate agent include glycine, oxine, 1-nitroso-2-naphthol, 2-mercaptobenzothiazole, and EDTA (ethylenediaminetetraacetic acid). Some kinds selected from glycine, oxine, 1-nitroso-2-naphthol, and 2-mercaptobenzothiazole can be used. At least one of the chelate agents is dissolved in pure water to form a chelate solution. The chelate agent serves as a complexing agent to form a chelate compound, and is preferred to a general complexing agent. Needless to say, such a complexing agent may be used instead of the chelate agent, and ammonia water can be used as the complexing agent. The chelate solution is preferably used, in which case generation of unnecessary crystal nuclei is suppressed to promote the crystal growth.

Since generation of unnecessary crystal nuclei is suppressed to inhibit generation of fine particles, a composite hydroxide with good particle size distribution can be obtained. Furthermore, the use of the chelate solution can slow an acid-base reaction, so that the reaction gradually progresses to form a nearly spherical secondary particle. Glycine can maintain the pH at 9 to 10, inclusive, or in the neighborhood thereof. Thus, a glycine solution is preferably used as the chelate solution, in which case the pH in the reaction vessel can be controlled in the formation of the composite hydroxide 98.

### Step S114

Next, in Step S114 in FIG. 3, the transition metal M source and the chelate agent are mixed, so that an acid solution is formed.

### Step S121

Next, in Step S121 in FIG. 3, an alkaline solution is prepared. As the alkaline solution, an aqueous solution containing sodium hydroxide, potassium hydroxide, lithium hydroxide, or ammonia can be used. An aqueous solution in which any of these substances is dissolved in pure water can be used. Alternatively, an aqueous solution in which multiple kinds selected from sodium hydroxide, potassium hydroxide, lithium hydroxide, and ammonia are dissolved in pure water may be used.

The pure water that is preferably used for the transition metal M source and the alkaline solution is water with a resistivity of 1 MΩ·cm or higher, preferably 10 MΩ·cm or higher, further preferably 15 MΩ·cm or higher. Water with the above-described resistivity has high purity and an extremely small amount of impurities.

### Step S122

As shown in Step S122 in FIG. 3, water is preferably prepared in a reaction vessel. The water may be an aqueous solution of a chelate agent, and pure water is preferably used. The use of pure water promotes nucleation, leading to formation of a composite hydroxide with a small particle diameter. The water prepared in a reaction vessel can be referred to as an adjustment liquid or a filling liquid in the reaction vessel. For the case of using a chelate solution, refer to the description for Step S13.

### Step S131

Next, in Step S131 in FIG. 3, an acid solution and an alkaline solution are mixed to be reacted with each other. The reaction can be referred to as a coprecipitation reaction, a neutralization reaction, or an acid-base reaction.

During the coprecipitation reaction of Step S131, the pH of the reaction system is preferably higher than or equal to 9.0 and lower than or equal to 11.5.

For example, when an alkaline solution is put in a reaction vessel and an acid solution is dropped into the reaction vessel, the pH of the aqueous solution in the reaction vessel is preferably kept in the above range. Similarly, the same applies to a case where the acid solution is put in the reaction vessel and the alkaline solution is dropped thereinto. The dropping rate of the acid solution or the alkaline solution is preferably higher than or equal to 0.01 mL/min when 200 mL to 350 mL of the solution is in the reaction vessel, in which case the pH conditions can be easily controlled. The reaction vessel contains a reaction container or the like.

The aqueous solution in the reaction vessel is preferably stirred with a stirring means. The stirring means includes a stirrer, an impeller, or the like. The impeller can have two to six blades, for example, when an impeller with four blades is employed, the four blades may be arranged to make a cross shape seen from above. The rotation number of the stirring means may be from 800 rpm to 1200 rpm, inclusive. A baffle plate may be provided in the reaction vessel to change the stirring direction and the rate of flow. The use of a baffle plate improves mixing efficiency and allows synthesis of more uniform composite hydroxide particles.

The temperature of the reaction vessel is preferably controlled to be higher than or equal to 50° C. and lower than or equal to 90° C. After the temperature of the reaction vessel falls within the above temperature range, dropping of the alkaline solution or the acid solution is preferably started.

The reaction vessel preferably has an inert atmosphere. Nitrogen or argon can be used as the inert atmosphere. In the case of the nitrogen atmosphere, a nitrogen gas may be introduced at a flow rate of 0.5 L/min to 2 L/min, inclusive.

In the reaction vessel, a reflux condenser is preferably placed. The nitrogen gas can be released from the reaction vessel and water vapor can be returned to the reaction vessel with use of the reflux condenser.

Through above-described coprecipitation reaction, the composite hydroxide 98 containing the transition metal M is precipitated.

### Step S132

Filtration is preferably performed to collect the composite hydroxide 98 as in Step S132 in FIG. 3. Suction filtration is preferred for the filtration. The filtration may be performed using an organic solvent (e.g., acetone) after a reaction product precipitated in the reaction vessel is washed with pure water.

### Step S133

As shown in Step S133 in FIG. 3, the composite hydroxide 98 after the filtration is preferably dried. For example, the composite hydroxide 98 is dried in a vacuum at higher than or equal to 60° C. and lower than or equal to 200° C. for longer than or equal to 0.5 hours and shorter than or equal to 20 hours, e.g., 12 hours. In this manner, the composite hydroxide 98 can be obtained.

In this manner, the composite hydroxide 98 containing the transition metal M can be obtained. In this specification and the like, the composite hydroxide 98 denotes a hydroxide of a plurality of metals. The composite hydroxide 98 can be referred to as a precursor of the positive electrode active material 101.

### Step S141

Next, in Step S141 in FIG. 4, a lithium source is prepared. For example, the atomic ratio of lithium to the total of nickel, cobalt, and manganese can be, when the total is 1, in the neighborhood of 1.0.

As the lithium source, for example, lithium hydroxide, lithium carbonate, or lithium nitrate can be used. In particular, a material having a low melting point among lithium compounds, such as lithium hydroxide (with the melting point of 462° C.), is preferably used. Since a positive electrode active material containing nickel at a high proportion easily causes cation mixing as compared with lithium cobalt oxide or the like, heating in Step S143 and the like needs to be performed at low temperatures. Therefore, it is preferable to use a material having a low melting point.

The particle diameter of the lithium source is preferably small because it facilitates a favorable reaction. A lithium source microparticulated by fluidized bed jet milling can be used, for example. The particle diameter here is an average particle diameter in particle diameter distribution (also referred to as an average particle diameter). The average particle diameter refers to D50 of the case where the particle diameter distribution is symmetrical. Note that D50 refers to a 50% cumulative secondary particle diameter calculated using a particle size distribution analyzer (SALD-2200 manufactured by Shimadzu Corporation) using a laser diffraction and scattering method. The particle size may be measured by measuring the major diameter of the cross section of the particle obtained by analysis with a SEM, a transmission electron microscope (TEM), or the like, instead of using laser diffraction particle size distribution measurement. Note that an example of a method for measuring D50 with a SEM,

TEM, or the like includes a method for measuring 20 or more particles to make a particle size distribution curve, and setting a particle diameter when the accumulation of particles accounts for 50% as D50.

### Step S142

Next, in Step S142 in FIG. 4, the composite hydroxide 98 and the lithium source are mixed. The mixing can be performed by a dry method or a wet method. For example, a ball mill or a bead mill can be used for the mixing. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. The cobalt compound and the lithium compound are sometimes pulverized during the mixing.

### Step S143

Then, heating is performed on the mixture of the composite hydroxide 98 and the lithium source. The heating in Step S143, heating in Step S145, and heating in Step S153 in FIG. 4 may be sometimes referred to as first heating, second heating, and third heating, respectively, so as to be distinguished from one another.

An electric furnace or a rotary kiln furnace can be used as a firing device for the heating. A crucible, a sagger, a setter, or a container used in the heating is preferably made of a material that hardly releases impurities. For example, a crucible made of alumina with a purity of 99.9% can be used. In the case of mass production, a sagger made of mullite cordierite (Al₂O₃·SiO₂·MgO) can be used, for example. Such a container is preferably heated with the lid on.

The heating in Step S143 is preferably performed at a temperature higher than or equal to 400° C. and lower than or equal to 750° C., further preferably higher than or equal to 650° C. and lower than or equal to 750° C. The time for the heating in Step S143 is preferably longer than or equal to 1 hour and shorter than or equal to 30 hours, further preferably longer than or equal to 2 hours and shorter than or equal to 20 hours.

The heating atmosphere is preferably an oxygen atmosphere or an oxygen-containing atmosphere that is dry air with few moisture (e.g., with a dew point lower than or equal to −50° C., preferably lower than or equal to −80° C.).

Furthermore, crushing is preferably performed in Step S144 after the heating. The crushing can be performed in a mortar, for example. Furthermore, classification may be performed using a sieve.

Next, heat treatment is performed in Step S145. The heating temperature in Step S145 is preferably higher than the heating temperature in Step S142. The heating in Step S142 is referred to as pre-baking, and the heating in Step S145 is referred to as main-baking, in some cases.

The temperature of the heating in Step S145 is preferably higher than 750° C. and lower than or equal to 1050° C. The time for the heating in Step S145 is preferably longer than or equal to 1 hour and shorter than or equal to 30 hours, further preferably longer than or equal to 2 hours and shorter than or equal to 20 hours.

Furthermore, a crushing step is preferably performed in Step S146 after the heating. The crushing can be performed in a mortar, for example. Furthermore, classification may be performed using a sieve. Through the above steps, a composite oxide is obtained.

### Step S151

Next, in Step S151, a Mg source is prepared. As the Mg source, magnesium carbonate, magnesium fluoride, or magnesium hydroxide is used.

### Step S152

Then, the composite oxide obtained in Step S146 and the Mg source are mixed.

### Step S153

Then, heating is performed on the mixture of the composite oxide and the Mg source. The heating in Step S153 is preferably performed at sufficiently high temperatures to increase the crystallite size of the positive electrode active material 101. The temperature range may depend on the composition of the transition metal M.

In the case where the proportion of nickel in the transition metal M is high, e.g., higher than or equal to 70%, the temperature is preferably higher than or equal to 750° C. Meanwhile, if the heating temperature in Step S153 is too high, it might cause reduction of the transition metal M such as nickel to the divalent state, for example. Accordingly, the heating temperature is preferably lower than or equal to 950° C., further preferably lower than or equal to 920° C., still further preferably lower than or equal to 900° C., for example.

In the case where the proportion of nickel used as the transition metal M is higher than or equal to 40% and lower than 70%, the heating temperature is preferably higher than or equal to 850° C., further preferably higher than or equal to 900° C., still further preferably lower than or equal to 1000° C., for example. Meanwhile, if the heating temperature in Step S153 is too high, it might cause a disadvantage similar to the above; thus, the heating temperature is preferably lower than or equal to 1050° C. For the other conditions of the heating, the description of Step S145 can be referred to.

Furthermore, a crushing step is preferably performed in Step S154 after the heating. The description of Step S144 can be referred to for the crushing.

Although a method in which heating is performed in Step S153 after the Mg source is mixed in Step S151 is described with reference to FIG. 4, one embodiment of the present invention is not limited thereto. Heating may be performed twice or more as the heating in Step S153.

Through the above steps, the positive electrode active material 101 can be formed.

This embodiment can be freely combined with the other embodiments.

### Embodiment 2

This embodiment describes examples of shapes of a secondary battery including the positive electrode active material 101 formed by the formation method described in the foregoing embodiment.

### Coin-Type Secondary Battery

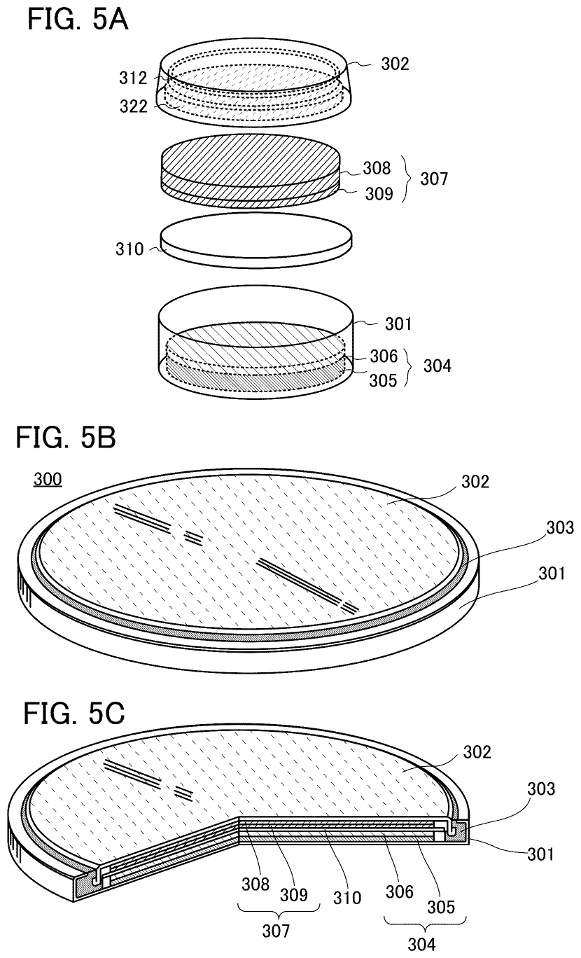

An example of a coin-type secondary battery is described. FIG. 5A, FIG. 5B, and FIG. 5C are an exploded perspective view, an external view, and a cross-sectional view of a coin-type (single-layer flat) secondary battery. Coin-type secondary batteries are mainly used in small electronic devices.

For easy understanding, FIG. 5A is a schematic view illustrating overlap (a vertical relation and a positional relation) between components. Thus, FIG. 5A and FIG. 5B do not completely correspond with each other.

In FIG. 5A, a positive electrode 304, a separator 310, a negative electrode 307, a spacer 322, and a washer 312 are overlaid. They are sealed with a negative electrode can 302, a positive electrode can 301, and a gasket. Note that the gasket for sealing is not illustrated in FIG. 5A. The spacer 322 and the washer 312 are used to protect the inside or fix the position of the components inside the cans at the time when the positive electrode can 301 and the negative electrode can 302 are bonded with pressure. For the spacer 322 and the washer 312, stainless steel or an insulating material is used.

The positive electrode 304 is a stack in which a positive electrode active material layer 306 is formed over a positive electrode current collector 305. Slurry containing the positive electrode active material 101 is applied onto the current collector and dried, so that the positive electrode active material layer 306 is formed. After the positive electrode active material layer 306 is formed, press may be performed. The slurry contains a conductive material and a solvent, in addition to the positive electrode active material 101. Note that a carbon material such as graphite or carbon fiber is used as the conductive material.

FIG. 5B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used. Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution, for example. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 5C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is fabricated.

With the above structure, the coin-type secondary battery 300 can have a high level of safety.

### Cylindrical Secondary Battery

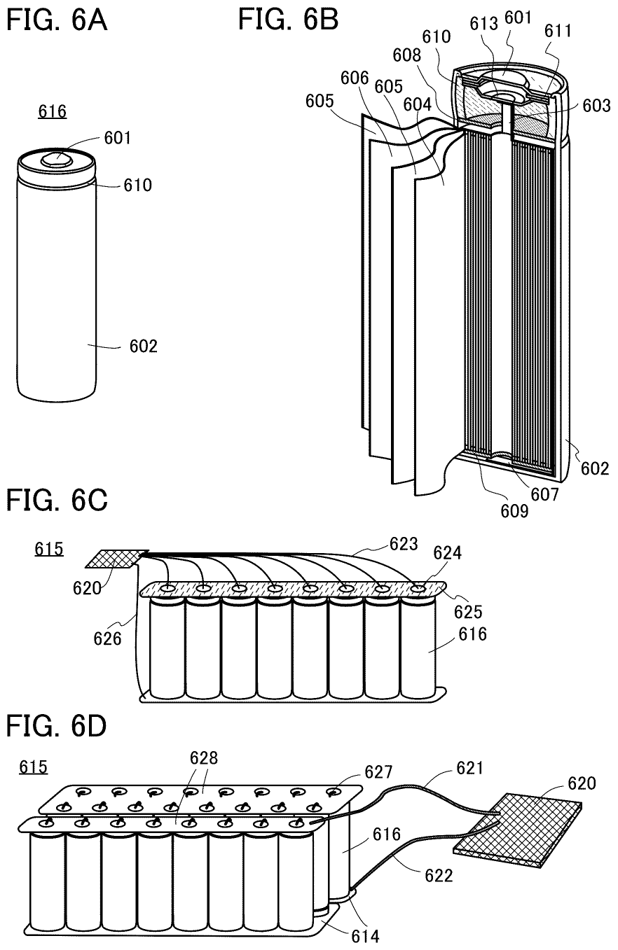

An example of a cylindrical secondary battery is described with reference to FIG. 6A. As illustrated in FIG. 6A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 6B schematically illustrates a cross section of a cylindrical secondary battery. The cylindrical secondary battery illustrated in FIG. 6B includes the positive electrode cap (battery cap) 601 on the top surface and the battery can (outer can) 602 on the side and bottom surfaces. The positive electrode cap 601 and the battery can (outer can) 602 are insulated from each other by the gasket (insulating gasket) 610.

Inside the battery can 602 having a hollow cylindrical shape, a wound body in which a strip-like positive electrode 604 and a strip-like negative electrode 606 are wound with a separator 605 located therebetween is provided. Although not illustrated, the wound body in which the strip-like positive electrode 604 and the strip-like negative electrode 606 are wound with the separator 605 located therebetween is wound around the central axis. One end of the battery can 602 is closed and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, and the like in order to prevent corrosion due to the electrolyte solution. Inside the battery can 602, the wound body in which the positive electrode, the negative electrode, and the separator are wound is provided between a pair of insulating plates 608 and 609 that face each other. The inside of the battery can 602 provided with the wound body is filled with a nonaqueous electrolyte solution (not illustrated). As the nonaqueous electrolyte solution, an electrolyte solution similar to that for the coin-type secondary battery can be used.

Since the positive electrode and the negative electrode of the cylindrical storage battery are wound, active materials are preferably formed on both sides of the current collectors.

The positive electrode active material 101 obtained in Embodiment 1 is used in the positive electrode 604, whereby the cylindrical secondary battery 616 can have a high level of safety.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 6C illustrates an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a charge and discharge control circuit for performing charging, discharging, and the like or a protection circuit for preventing overcharging and/or overdischarging can be used.

FIG. 6D illustrates an example of the power storage system 615. The power storage system 615 includes a plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel or connected in series, or may be connected in parallela and then further connected in series. With the power storage system 615 including the plurality of secondary batteries 616, large electric power can be extracted.

The plurality of secondary batteries 616 may be connected in parallel, and then those sets may be connected in series.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 6D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

### Other Structure Examples of Secondary Battery

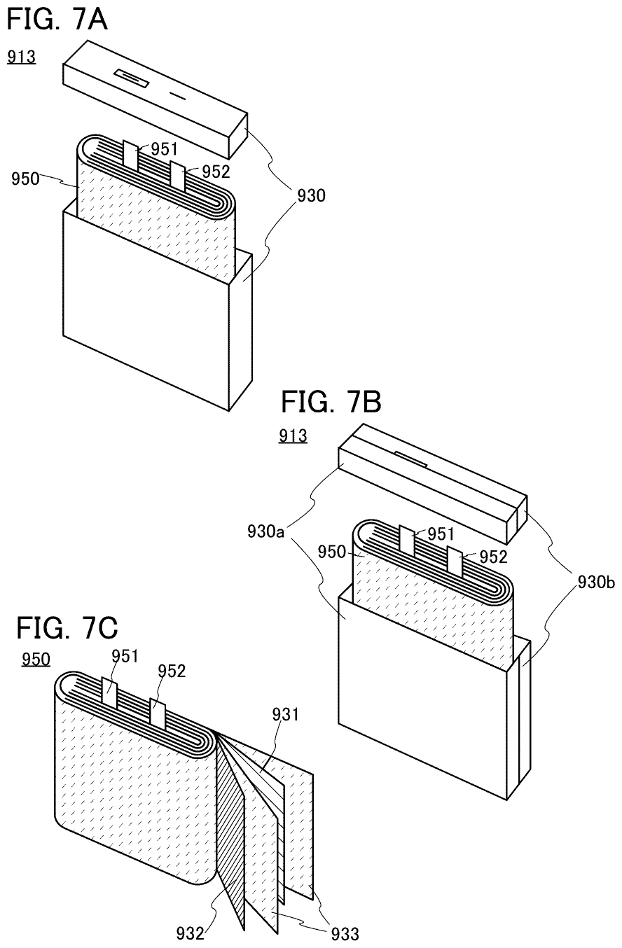

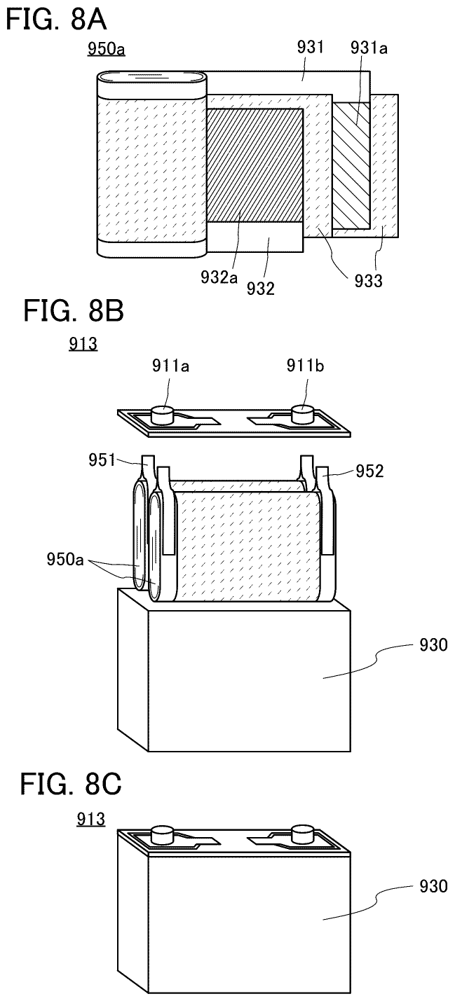

Structure examples of secondary batteries are described with reference to FIG. 7 and FIG. 8.

A secondary battery 913 illustrated in FIG. 7A includes a wound body 950 provided with a terminal 951 and a terminal 952 inside a housing 930. The wound body 950 is immersed in an electrolyte solution inside the housing 930. The terminal 952 is in contact with the housing 930. The use of an insulator or the like inhibits contact between the terminal 951 and the housing 930. Note that in FIG. 7A, the housing 930 divided into two pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 7B, the housing 930 in FIG. 7A may be formed using a plurality of materials. For example, in the secondary battery 913 in FIG. 7B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 7C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be overlaid.

As illustrated in FIG. 8, the secondary battery 913 may include a wound body 950a. The wound body 950a illustrated in FIG. 8A includes the negative electrode 931, the positive electrode 932, and the separators 933. The negative electrode 931 includes a negative electrode active material layer 931a. The positive electrode 932 includes a positive electrode active material layer 932a.

The positive electrode active material 101 obtained in Embodiment 1 is used in the positive electrode 932, whereby the secondary battery 913 can have a high level of safety.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 8B, the negative electrode 931 is electrically connected to the terminal 951 by ultrasonic bonding, welding, or pressure bonding. The terminal 951 is electrically connected to a terminal 911a. The positive electrode 932 is electrically connected to the terminal 952 by ultrasonic bonding, welding, or pressure bonding. The terminal 952 is electrically connected to a terminal 911b.

As illustrated in FIG. 8C, the wound body 950a and an electrolyte solution are covered with the housing 930, whereby the secondary battery 913 is completed. The housing 930 is preferably provided with a safety valve, an overcurrent protection element, and the like. A safety valve is a valve to be released by a predetermined internal pressure of the housing 930 in order to prevent the battery from exploding.

As illustrated in FIG. 8B, the secondary battery 913 may include a plurality of wound bodies 950a. The use of the plurality of wound bodies 950a enables the secondary battery 913 to have higher discharge capacity. The description of the secondary battery 913 in FIG. 7A to FIG. 7C can be referred to for the other components of the secondary battery 913 in FIG. 8A and FIG. 8B.

### Laminated Secondary Battery

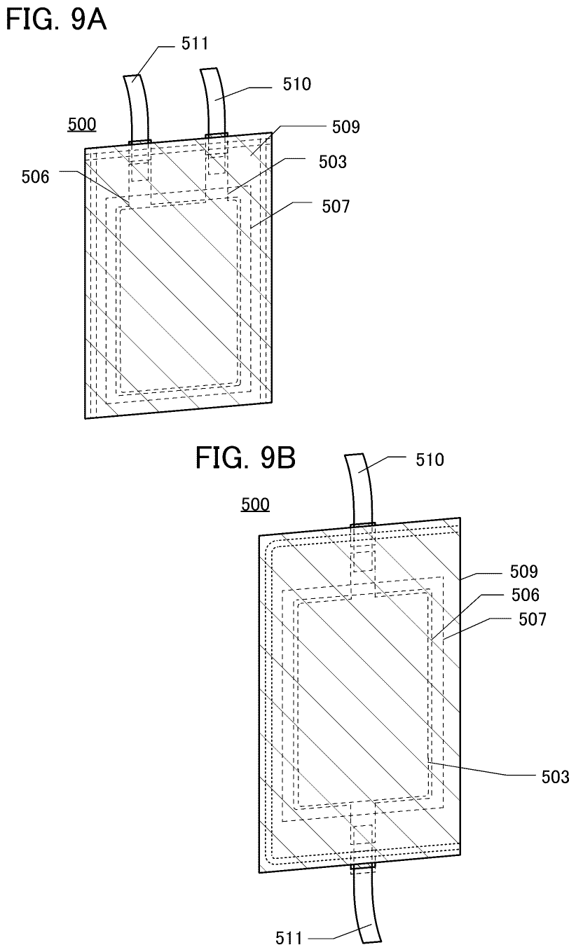

Next, examples of the appearance of a laminated secondary battery are illustrated in FIG. 9A and FIG. 9B. FIG. 9A and FIG. 9B each include a positive electrode 503, a negative electrode 506, a separator 507, an exterior body 509, a positive electrode lead electrode 510, and a negative electrode lead electrode 511.

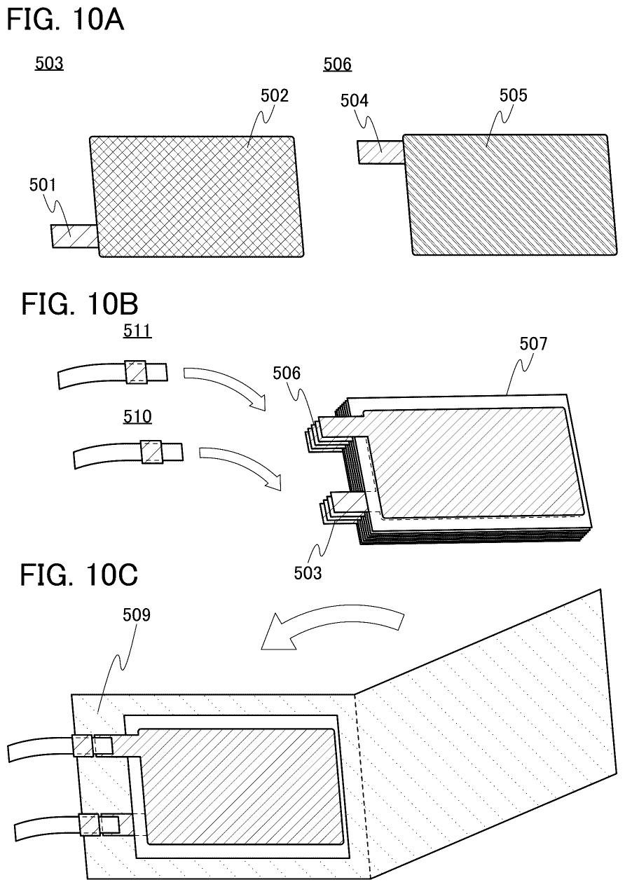

FIG. 10A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas or the shapes of the tab regions included in the positive electrode and the negative electrode are not limited to those illustrated in FIG. 10A.

### Method for Fabricating Laminated Secondary Battery

An example of a method for fabricating the laminated secondary battery having the appearance illustrated in FIG. 9A will be described with reference to FIGS. 10B and 10C.

First, the negative electrode 506, the separator 507, and the positive electrode 503 are stacked. FIG. 10B illustrates the negative electrodes 506, the separators 507, and the positive electrodes 503 that are stacked. The secondary battery described here as an example includes five negative electrodes and four positive electrodes. The component at this stage can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a dashed line as illustrated in FIG. 10C. Then, the outer edges of the exterior body 509 are bonded to each other. The bonding can be performed by thermocompression, for example. At this time, a part (or one side) of the exterior body 509 is left unbonded (to provide an inlet) so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be fabricated.

The positive electrode active material 101 obtained in Embodiment 1 is used in the positive electrodes 503, whereby the secondary battery 500 can have a high level of safety.

### Embodiment 3

In this embodiment, examples of vehicles each including the secondary battery of one embodiment of the present invention are described.

The secondary battery can be used in vehicles, typically automobiles. Examples of the automobiles include next-generation clean energy vehicles such as hybrid vehicles (HVs), electric vehicles (EVs), and plug-in hybrid vehicles (also referred to as PHEVs or PHVs). The secondary battery can be used as one of the power sources provided in the automobiles. The vehicle is not limited to an automobile. Examples of the vehicles include a train, a monorail train, a ship, a submarine (a deep-submergence vehicle and an unmanned submarine), a flying object (a helicopter, an unmanned aircraft (a drone), an airplane, a rocket, and artificial satellite), an electric bicycle, and an electric motorcycle. The secondary battery of one embodiment of the present invention can be used in these vehicles.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 needs high output but is not required to have very high capacity, and the capacity of the second battery 1311 is lower than that of the first batteries 1301a and 1301b.

The internal structure of the first battery 1301a may be the wound structure illustrated in FIG. 7C or FIG. 8A or the stacked structure illustrated in FIG. 9A or FIG. 9B.

Although this embodiment shows an example where the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. A plurality of secondary batteries can be collectively referred to as an assembled battery.

An in-vehicle secondary battery includes a service plug or a circuit breaker that can cut off high voltage without the use of equipment in order to cut off electric power from a plurality of secondary batteries, which is provided in the first battery 1301a.

Electric power from the first batteries 1301a and 1301b is mainly used to rotate the motor 1304 and is also supplied to in-vehicle parts for 42 V (such as an electric power steering 1307, a heater 1308, and a defogger 1309) through a DC-DC circuit 1306. In the case where there is a rear motor 1317 for the rear wheels, the first battery 1301a is used to rotate the rear motor 1317.

The second battery 1311 supplies electric power to in-vehicle parts for 14 V (such as an audio 1313, power windows 1314, and lamps 1315) through a DC-DC circuit 1310.

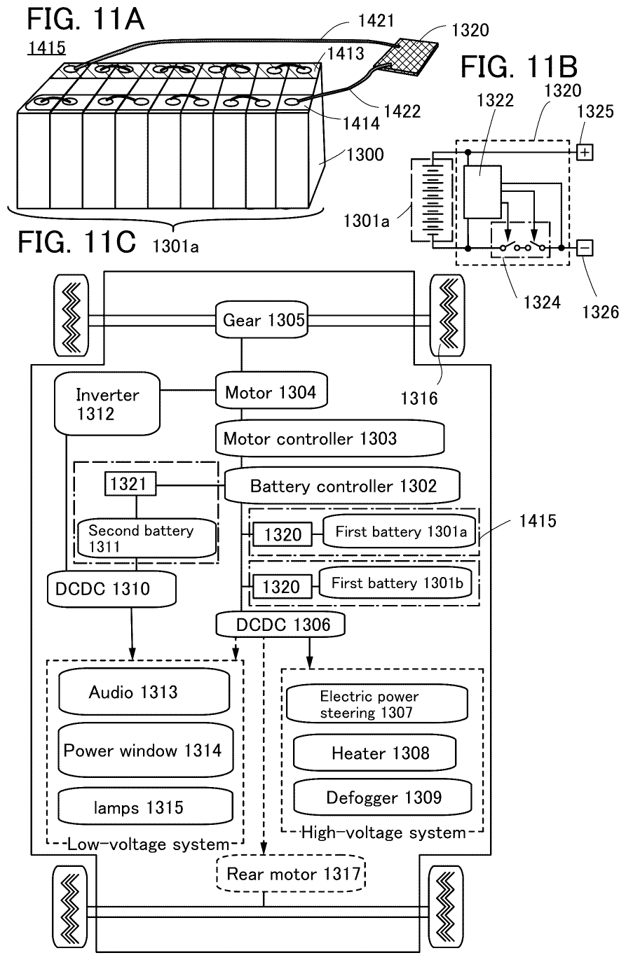

Next, the first battery 1301a is described with reference to FIG. 11A.

FIG. 11A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode of each battery is fixed by a fixing portion 1414 made of an insulator. Although this embodiment shows an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414, a battery container box, or the like. Furthermore, the one electrode of each battery is electrically connected to a control circuit portion 1320 through a wiring 1421. The other electrode of each battery is electrically connected to the control circuit portion 1320 through a wiring 1422.

Next, FIG. 11B illustrates an example of a block diagram of the battery pack 1415 illustrated in FIG. 11A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and imposes the upper limit of current from the outside, the upper limit of output current to the outside, or the like. The range from the lower limit voltage to the upper limit voltage of the secondary battery falls within the recommended voltage range. When a voltage falls outside the range, the switch portion 1324 operates and functions as a protection circuit. The control circuit portion 1320 can also be referred to as a protection circuit because it controls the switch portion 1324 to prevent overdischarging and/or overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to including a switch having a Si transistor using single crystal silicon; the switch portion 1324 may be formed using a power transistor containing germanium (Ge), silicon germanium (SiGe), gallium arsenide (GaAs), gallium aluminum arsenide (GaAlAs), indium phosphide (InP), silicon carbide (SiC), zinc selenide (ZnSe), gallium nitride (GaN), gallium oxide (GaOₓ, where x is a real number greater than 0), or the like.

An example in which a lithium-ion battery is used for an electric vehicle (EV) is described with reference to FIG. 11C. The first batteries 1301a and 1301b mainly supply electric power to in-vehicle parts for 42 V (for a high-voltage system), and the second battery 1311 supplies electric power to in-vehicle parts for 14 V (for a low-voltage system). A lead battery is usually used for the second battery 1311 due to cost advantage.

In this embodiment, an example in which a lithium-ion battery is used as both the first battery 1301a and the second battery 1311 is described. As the second battery 1311, a lead storage battery, an all-solid-state battery, or an electric double layer capacitor may alternatively be used.

Regenerative energy generated by rolling of tires 1316 is transmitted to the motor 1304 through a gear 1305, and is stored in the second battery 1311 through a motor controller 1303, a battery controller 1302, or the control circuit portion 1321. Alternatively, the regenerative energy is stored in the first battery 1301a through the battery controller 1302 and the control circuit portion 1320. Alternatively, the regenerative energy is stored in the first battery 1301b through the battery controller 1302 and the control circuit portion 1320. For efficient charging with regenerative energy, the first batteries 1301a and 1301b are preferably capable of fast charging.

The battery controller 1302 can set the charge voltage, charge current, and the like of the first batteries 1301a and 1301b. The battery controller 1302 can set charge conditions in accordance with charge characteristics of a secondary battery used, so that fast charging can be performed.

Although not illustrated, when the electric vehicle is connected to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or a connection cable of the charger is sometimes provided with a control circuit. The control circuit portion 1320 is also referred to as an electronic control unit (ECU). The ECU is connected to a controller area network (CAN) provided in the electric motor vehicle. The CAN is a type of a serial communication standard used as an in-vehicle LAN. The ECU includes a microcomputer. Moreover, the ECU uses a CPU or a GPU.

External chargers installed at charge stations and the like have a 100 V outlet, a 200 V outlet, or a three-phase 200V outlet with 50 kW, for example. Furthermore, charging can be performed by electric power supplied from external charge equipment with a contactless power feeding method or the like.

For fast charging, secondary batteries that can withstand charging at high voltage have been desired to perform charging in a short time.

It is possible to achieve a secondary battery in which graphene is used as a conductive material, the electrode layer is formed thick to suppress a reduction in capacity while increasing the loading amount, and the electrical characteristics are significantly improved in synergy with maintenance of high capacity. This secondary battery is particularly effectively used in a vehicle and can achieve a vehicle that has a long range, specifically a driving range per charge of 500 km or greater, without increasing the proportion of the weight of the secondary battery to the weight of the entire vehicle.

Specifically, in the secondary battery in this embodiment, the use of the positive electrode active material 100 described in Embodiment 1 can increase the operating voltage, and the increase in charge voltage can increase the available capacity. Moreover, using the positive electrode active material 100 described in Embodiment 1 in the positive electrode can provide an automotive secondary battery having a high level of safety.

Next, examples in which the secondary battery of one embodiment of the present invention is mounted on a vehicle, typically a transport vehicle, will be described.

Mounting the secondary battery illustrated in any one of FIG. 6D, FIG. 8C, and FIG. 11A on vehicles can achieve next-generation clean energy vehicles such as hybrid vehicles (HVs), electric vehicles (EVs), and plug-in hybrid vehicles (PHVs). The secondary battery can also be mounted on agricultural machines, motorized bicycles including motor-assisted bicycles, motorcycles, electric wheelchairs, electric carts, vessels, submarines, aircraft, rockets, artificial satellites, space probes, planetary probes, or spacecraft. The secondary battery of one embodiment of the present invention can have high capacity. Thus, the secondary battery of one embodiment of the present invention is suitable for reduction in size and weight and is preferably used in transport vehicles.

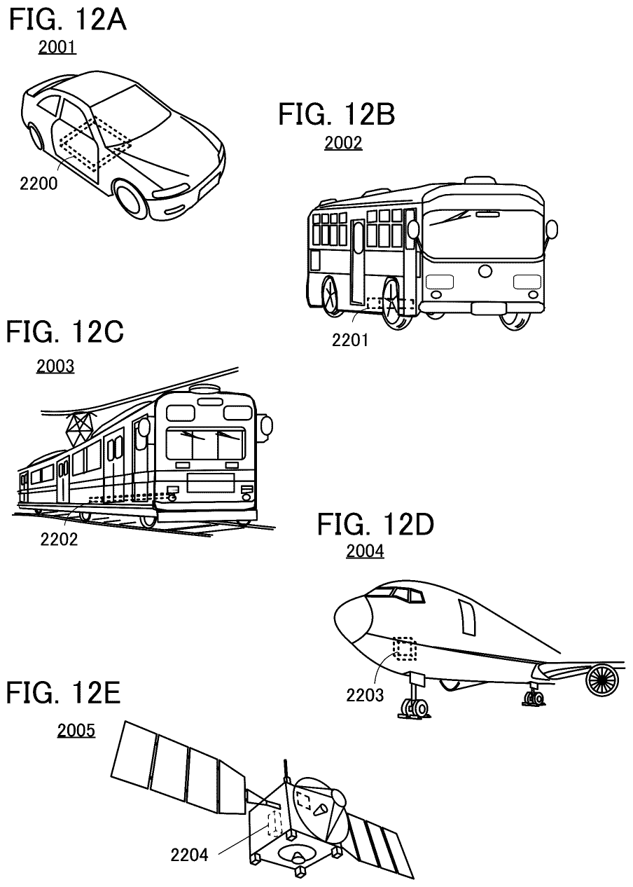

FIGS. 12A to 12D illustrate examples of transport vehicles using one embodiment of the present invention. An automobile 2001 illustrated in FIG. 12A is an electric vehicle that runs on the power of an electric motor. Alternatively, the automobile 2001 is a hybrid electric vehicle capable of driving using either an electric motor or an engine as appropriate. In the case where the secondary battery is mounted on the vehicle, the secondary battery exemplified in Embodiment 5 is provided at one position or several positions. The automobile 2001 illustrated in FIG. 12A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery included in the automobile 2001 is supplied with electric power through external charge equipment by a plug-in system, a contactless power feeding system, or the like. In charging, a given method such as CHAdeMO (registered trademark) or Combined Charging System can be employed as a charge method, the standard of a connector, and the like as appropriate. Charge equipment may be a charge station provided in a commerce facility or a power source in a house. For example, with the use of the plug-in technique, the power storage device mounted on the automobile 2001 can be charged by being supplied with electric power from outside. The charging can be performed by converting AC electric power into DC electric power through a converter such as an AC-DC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 12B illustrates a large transporter 2002 having a motor controlled by electricity as an example of a transport vehicle. A secondary battery module of the transporter 2002 includes a cell unit of four secondary batteries with a nominal voltage of 3.0 V or higher and 5.0 V or lower, for example, and 48 cells are connected in series to have a maximum voltage of 170 V. A battery pack 2201 has the same function as that in FIG. 12A except, for example, the number of secondary batteries configuring the secondary battery module; thus, the description is omitted.

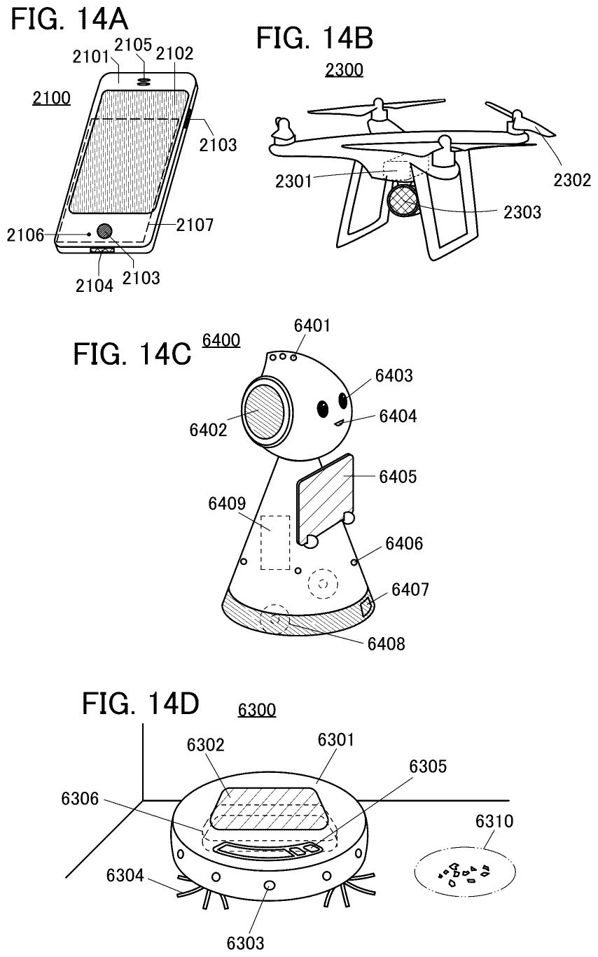

FIG. 12C illustrates a large transportation vehicle 2003 having a motor controlled by electricity as an example. A secondary battery module of the transportation vehicle 2003 has 100 or more secondary batteries with a nominal voltage of 3.0 V or higher and 5.0 V or lower connected in series, and the maximum voltage is 600 V. Thus, the secondary batteries are required to have few variations in the characteristics. With the use of a secondary battery with the positive electrode active material 101 described in Embodiment 1 to Embodiment 3, a secondary battery with stable battery characteristics can be fabricated, which enables the volume production at low costs in terms of the yield. A battery pack 2202 has the same function as that in FIG. 14A except, for example, the number of secondary batteries configuring the secondary battery module; thus, the description is omitted.

FIG. 12D illustrates an aircraft 2004 having a combustion engine as an example. The aircraft 2004 illustrated in FIG. 12D is regarded as a portion of transportation vehicles because it has wheels for takeoff and landing, and includes a battery pack 2203 that includes a charge control device and a secondary battery module configured by connecting a plurality of secondary batteries.

The secondary battery module of the aircraft 2004 has eight 4 V secondary batteries connected in series and has a maximum voltage of 32 V, for example. The battery pack 2203 has the same function as that in FIG. 12A except, for example, the number of secondary batteries configuring the secondary battery module; thus, the description is omitted.

FIG. 12E illustrates an artificial satellite 2005 including a secondary battery 2204 as an example. The artificial satellite 2005 is desired to develop no trouble due to ignition because the artificial satellite 2005 is used in a cosmic space; thus, the secondary battery 2204 which is a highly safe secondary battery of one embodiment of the present invention is preferably provided. It is further preferable that the secondary battery 2204 be mounted inside the artificial satellite 2005 while being covered with a heat-retaining member.

### Embodiment 4

In this embodiment, examples in which the lithium-ion battery of one embodiment of the present invention is mounted on a motorcycle and a bicycle will be described as examples of mounting a secondary battery in a vehicle.

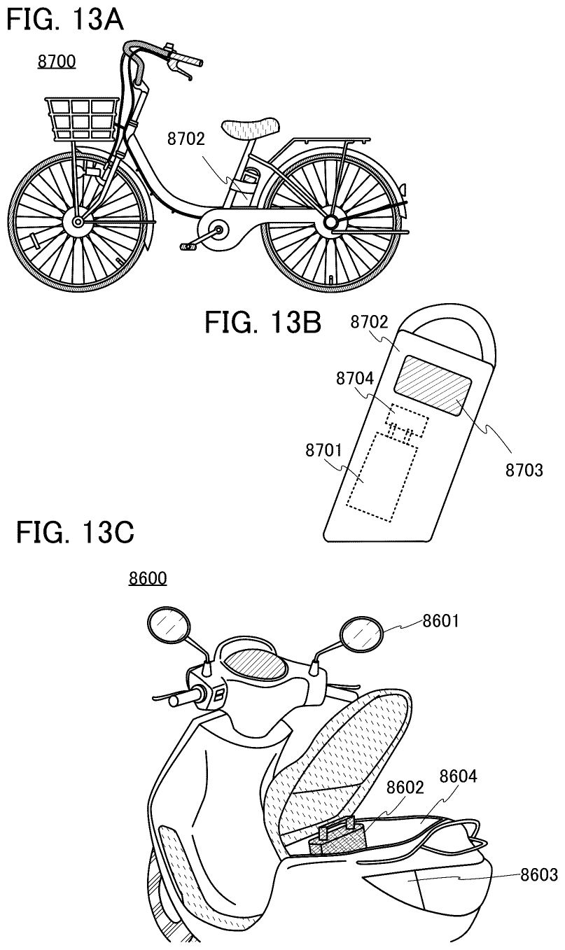

FIG. 13A shows an example of an electric bicycle using the power storage device of one embodiment of the present invention. The power storage device of one embodiment of the present invention can be used for an electric bicycle 8700 illustrated in FIG. 13A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 13B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery, which is exemplified in Embodiment 6. The control circuit 8704 is electrically connected to a positive electrode and a negative electrode of the storage battery 8701. When the control circuit 8704 is used in combination with a secondary battery including a positive electrode using the positive electrode active material 101 obtained in Embodiment 1, synergetic effect in terms of safety can be obtained. The secondary battery including a positive electrode using the positive electrode active material 101 obtained in Embodiment 1 and the control circuit 8704 are highly safe, and can contribute greatly to elimination of accidents due to secondary batteries, such as fires.

FIG. 13C shows an example of a motorcycle using the power storage device of one embodiment of the present invention. A motor scooter 8600 illustrated in FIG. 13C includes a power storage device 8602, side mirrors 8601, and indicator lights 8603. The power storage device 8602 can supply electricity to the indicator lights 8603. The power storage device 8602 including a plurality of secondary batteries including a positive electrode using the positive electrode active material 101 obtained in Embodiment 1 can have high capacity and contribute to a reduction in size.

In the motor scooter 8600 illustrated in FIG. 13C, the power storage device 8602 can be stored in an under-seat storage unit 8604. The power storage device 8602 can be stored in the under-seat storage unit 8604 even when the under-seat storage unit 8604 is small.

### Embodiment 5

In this embodiment, examples of electronic devices each including the secondary battery of one embodiment of the present invention are described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book reader, and a mobile phone.

FIG. 14A illustrates an example of a mobile phone. A mobile phone 2100 includes a housing 2101 in which a display portion 2102 is incorporated, an operation button 2103, an external connection port 2104, a speaker 2105, a microphone 2106, and the like. The mobile phone 2100 includes a secondary battery 2107. The use of the secondary battery 2107 having a positive electrode using the positive electrode active material 101 described in Embodiment 1 achieves high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication based on an existing communication standard. For example, mutual communication between the mobile phone 2100 and a headset capable of wireless communication can be performed, and thus hands-free calling is possible.

Moreover, the mobile phone 2100 includes the external connection port 2104, and data can be directly transmitted to and received from another information terminal via a connector. In addition, charging can be performed via the external connection port 2104. Note that the charge operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 14B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 101 obtained in Embodiment 1 has a high energy density and a high degree of safety, and thus can be used safely for a long time over a long period of time and is preferable as the secondary battery included in the unmanned aircraft 2300.

FIG. 14C illustrates an example of a robot. A robot 6400 illustrated in FIG. 14C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material 101 obtained in Embodiment 1 has a high energy density and a high degree of safety, and thus can be used safely for a long time over a long period of time and is preferable as the secondary battery 6409 included in the robot 6400.

FIG. 14D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

The cleaning robot 6300 can determine whether there is an obstacle such as a wall, furniture, or a step by analyzing images taken by the cameras 6303. In the case where the cleaning robot 6300 detects an object that is likely to be caught in the brush 6304 (e.g., a wire) by image analysis, the rotation of the brush 6304 can be stopped. The cleaning robot 6300 further includes, in its inner region, the secondary battery 6306 of one embodiment of the present invention and a semiconductor device or an electronic component. A secondary battery including a positive electrode using the positive electrode active material 101 obtained in Embodiment 1 has a high energy density and a high degree of safety, and thus can be used safely for a long time over a long period of time and is preferable as the secondary battery 6306 included in the cleaning robot 6300.

### Example

In this example, the positive electrode active material of one embodiment of the present invention was manufactured and its shape was evaluated.

In this example, in accordance with the method described in Embodiment 1, a composite hydroxide (Ni_{0.8}Co_{0.1}Mn_{0.1}(OH)₂) in which the mixing ratio of nickel to cobalt to manganese was Ni:Co:Mn=8:1:1 was formed. The obtained composite hydroxide and a lithium hydroxide were mixed, heated, crushed, and then further heated to give a composite oxide. The heating conditions (S143) after the mixing were at 700° C. for 10 hours, and the subsequent heating conditions (S145) were at 800° C. for 10 hours. The obtained composite oxide can be expressed as Li_{1.01}Ni_{0.8}Co_{0.1}Mn_{0.1}O₂.

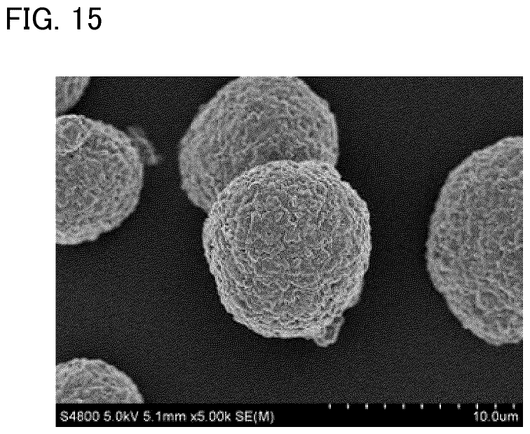

Then, magnesium carbonate used as the Mg source was mixed with the composite oxide. The mixing was performed such that the concentration of magnesium, with respect to the total of nickel, manganese, and cobalt, was 1 atomic %. After the mixing, heat treatment was performed to give a positive electrode active material (sample). FIG. 15 shows a plan SEM image of the obtained positive electrode active material. Note that the heating conditions (S153) after the mixing with magnesium carbonate were at 800° C. for 10 hours.

After that, a half cell was assembled using the above positive electrode active material, and the battery characteristics were evaluated. The battery characteristics evaluation using a half cell is a suitable evaluation method for verifying the characteristics of a positive electrode active material. In this example, a coin-type half cell was used, and cycle performance was evaluated as battery characteristics of the half cell.

Acetylene black was used as a conductive auxiliary agent for the positive electrode. As the positive electrode active materials, positive electrode active materials corresponding to the sample, a comparative example 1, and a comparative example 2 were prepared. Each of them was mixed with acetylene black, a binder (PVDF), and a solvent (NMP) to form a slurry, and the slurry was applied onto a current collector of aluminum (with a thickness of 20 μm). After the slurry was applied to the current collector, the solvent used for the mixing was volatilized. After that, pressure was applied at 210 kN/m with the use of a roll press machine. The temperature of the roll was 120° C. Through the above process, the positive electrodes were obtained.

Using the formed positive electrodes, CR2032-type half cells (coin-type battery cells) (with a diameter of 20 mm and a height of 3.2 mm) were fabricated.

Lithium metal was used for counter electrodes of the half cells.

As an electrolyte of the half cells, 1 mol/L of lithium hexafluorophosphate (LiPF₆) was used, and ethylene carbonate (EC) and diethyl carbonate (DEC) being mixed at EC:DEC=3:7 (volume ratio) were used as a solvent. Vinylene carbonate (VC) was added as an additive at 2 wt % with respect to the total solvent mixed above.

As a separator of the half cell, 25-μm-thick polypropylene was used.

A positive electrode can and a negative electrode can of the half cell that were formed of stainless steel (SUS) were used.

In the evaluation of the cycle performance, the charge voltage was set at 4.5 V, and the temperature of a constant-temperature unit in which the half cell was placed was set at 45° C. Charge was performed by constant current (CC)/constant voltage (CV) at a rate of 0.5 C (1 C was 200 mA/g) and finished when the rate was 0.05 C. Discharge was performed by constant current (CC) at a rate of 0.5 C (1 C was 200 mA/g) and finished when the voltage was 2.5 V. Downtime may be provided between the discharge and the next charge; a 10-minute downtime was provided in this example. As a cycle test for evaluating the cycle performance, the charge and the discharge described above were repeated 100 times.

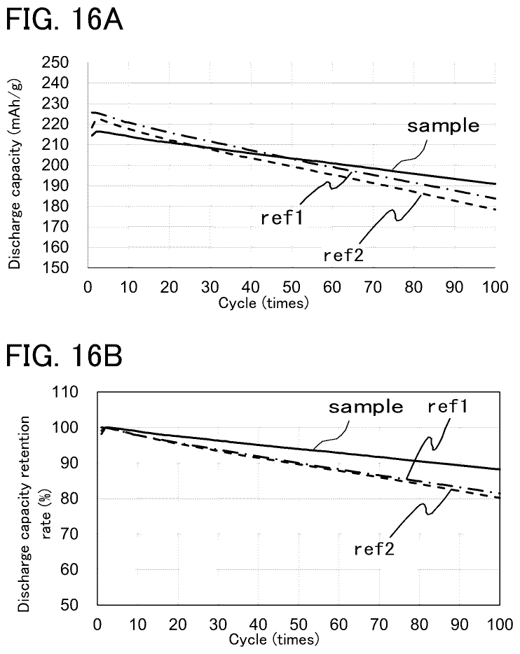

FIG. 16A and FIG. 16B show the cycle test results of the sample, the comparative example 1, and the comparative example 2. In FIG. 16A and FIG. 16B, the sample is indicated by a solid line, the comparative example 1 is indicated by a dashed-dotted line, and the comparative example 2 is indicated by a dashed line. In FIG. 16A, the vertical axis represents the discharge capacity and the horizontal axis represents the number of cycles, and in FIG. 16B, the vertical axis represents the discharge capacity retention rate and the horizontal axis represents the number of cycles.

For the comparative example 1 (ref1), a positive electrode active material that was not mixed with the Mg source was used. The conditions of the heat treatment were the same. That is, the heating conditions (S143) after the mixing with the lithium hydroxide were at 700° C. for 10 hours, and the subsequent heating conditions (S145) were at 800° C. for 10 hours.

The comparative example 2 (ref2) is an example in which magnesium carbonate was also mixed at the time of mixing with lithium hydroxide. The conditions of the heat treatment were the same. The heating conditions after the mixing of lithium hydroxide and magnesium carbonate were at 700° C. for 10 hours, and the subsequent heating conditions were at 800° C. for 10 hours.

As shown in FIG. 16A and FIG. 16B, the results showing that the sample in this example exhibited the best cycle performance as compared with the comparative example 1 and the comparative example 2 were obtained. In other words, the cycle performance was obtained in which a reduction in discharge capacity was small even when the number of cycles was large. Thus, mixing magnesium carbonate in NCM can improve the cycle performance; it was further found that a process in which mixing of lithium hydroxide, heating, mixing of magnesium carbonate, and then heating were performed in this order was more effective than a process in which mixing of lithium hydroxide and magnesium carbonate and then heating were performed.

### Reference Numerals

98: composite hydroxide, 100m layer containing magnesium, 100: primary particle, 101: positive electrode active material, 101a positive electrode active material, 101b positive electrode active material, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 312: washer, 322: spacer, 500: secondary battery, 501: positive electrode current collector, 502: positive electrode active material layer, 503: positive electrode, 504: negative electrode current collector, 505: negative electrode active material layer, 506: negative electrode, 507: separator, 509: exterior body, 510: positive electrode lead electrode, 511: negative electrode lead electrode, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 613: safety valve mechanism, 614: conductive plate, 615: power storage system, 616: secondary battery, 620: control circuit, 621: wiring, 622: wiring, 623: wiring, 624: conductor, 625: insulator, 626: wiring, 627: wiring, 628: conductive plate, 911a: terminal, 911b: terminal, 913: secondary battery, 930a: housing, 930b: housing, 930: housing, 931a: negative electrode active material layer, 931: negative electrode, 932a: positive electrode active material layer, 932: positive electrode, 933: separator, 950a: wound body, 950: wound body, 951: terminal, 952: terminal, 1300: rectangular secondary battery, 1301a: first battery, 1301b: first battery, 1302: battery controller, 1303: motor controller, 1304: motor, 1305: gear, 1306: DC-DC circuit, 1307: electric power steering, 1308: heater, 1309: defogger, 1310: DC-DC circuit, 1311: second battery, 1312: inverter, 1313: audio, 1314: power window, 1315: lamps, 1316: tire, 1317: rear motor, 1320: control circuit portion, 1321: control circuit portion, 1322: control circuit portion, 1324: switch portion, 1413: fixing portion, 1414: fixing portion, 1415: battery pack, 1421: wiring, 1422: wiring, 2001: automobile, 2002: transporter, 2003: transportation vehicle, 2004: aircraft, 2005: artificial satellite, 2100: mobile phone, 2101: housing, 2102: display portion, 2103: operation button, 2104: external connection port, 2105: speaker, 2106: microphone, 2107: secondary battery, 2200: battery pack, 2201: battery pack, 2202: battery pack, 2203: battery pack, 2204: secondary battery, 2300: unmanned aircraft, 2301: secondary battery, 2302: rotor, 2303: camera, 6300: cleaning robot, 6301: housing, 6302: display portion, 6303: camera, 6304: brush, 6305: operation button, 6306: secondary battery, 6310: dust, 6400: robot, 6401: illuminance sensor, 6402: microphone, 6403: upper camera, 6404: speaker, 6405: display portion, 6406: lower camera, 6407: obstacle sensor, 6408: moving mechanism, 6409: secondary battery, 8600: scooter, 8601: side mirror, 8602: power storage device, 8603: indicator light, 8604: under-seat storage unit, 8700: electric bicycle, 8701: storage battery, 8702: power storage device, 8703: display portion, 8704: control circuit

1. A method for manufacturing a positive electrode active material comprising:
supplying an aqueous solution comprising a water-soluble nickel salt, a water-soluble cobalt salt, and a water-soluble manganese salt, and an alkaline solution to a reaction vessel and mixing the aqueous solution and the alkaline solution in the reaction vessel to precipitate a compound comprising at least nickel, cobalt, and manganese;
heating a first mixture in which the compound and a lithium compound are mixed at a first heating temperature and crushing or grinding the first mixture;
heating the first mixture at a second heating temperature; and
heating a second mixture obtained by mixing the crushed or ground first mixture and a magnesium compound at a third heating temperature.

2. The method for manufacturing a positive electrode active material according to claim 1, wherein the alkaline solution is an aqueous solution comprising sodium hydroxide.

3. The method for manufacturing a positive electrode active material according to claim 1, wherein pH of the mixed solution obtained by mixing the aqueous solution and the alkaline solution is greater than or equal to 9.0 and less than or equal to 12.0.

4. The method for manufacturing a positive electrode active material according to claim 1, wherein an aqueous solution comprising glycine is added when the compound is precipitated by mixing the aqueous solution and the alkaline solution.

5. The method for manufacturing a positive electrode active material according to claim 1, wherein a range of the first heating temperature is higher than or equal to 400° C. and lower than or equal to 750° C.

6. The method for manufacturing a positive electrode active material according to claim 1, wherein a range of the second heating temperature and a range of the third heating temperature are higher than or equal to 750° C. and lower than or equal to 1050° C.

7. A secondary battery comprising a positive electrode, a negative electrode, and an electrolyte,
wherein the positive electrode comprises a positive electrode active material layer comprising nickel, cobalt, and manganese,
wherein the positive electrode active material layer comprises a secondary particle,
wherein the secondary particle comprises a plurality of primary particles,
wherein at least one primary particle of the plurality of primary particles comprises, in its surface portion, a layer comprising magnesium, and
wherein a thickness of the layer comprising magnesium is greater than or equal to 1 nm and less than or equal to 10 nm.
